(19) United States
(12) Patent Application Publication
(10) Pub. No.: US 2002/0083636 A1
(43) Pub. Date: Jul. 4, 2002

(54) Castable, deep-swimming fishing lure

(76) Inventor: David L. Thorne, Kaysville, UT (US)

Correspondence Address: DAVID L. THORNE, 1759 South 450 East, Kaysville, UT, 84037, US

(21) Appl. No.: 09/750,460

(22) Filed: Dec. 28, 2000

(51) Int. Cl. A01K 85/00

(52) U.S. Cl. 43/42.03

(57) ABSTRACT

A bimodal, two part weighted lure which exhibits a remarkable simulation of life-form swimming action while being towed through water. Weights inherently disposed within the lure permits casting, jigging and trolling without additional weight being added to fishing line external to the lure. The lure begins the swimming action immediately upon being displaced from a resting state. Weights in both parts of the lure cooperate to randomize both direction and rate of oscillations to make the swimming action seem real. Novel apparatus for hiding a loop whereat fishing line is affixed to steer and tow the lure is disclosed. Use of a lure made according to the invention with spinner bait and buzz bait wire forms is also disclosed.

### FIELD OF THE INVENTION

The present invention relates generally to jigging lures and to lures which are inherently weighted to permit casting without adding additional weight to a line to which the lure is affixed. Further, the present invention relates to lures which exhibit a realistic simulation of a swimming fish.

### DESCRIPTION OF RELATED ART

It has long been a desire to make a fishing lure which simulates the swimming motion of a fish as it is moved through water. A number of fishing lures are currently available commercially which exhibit some simulation of swimming. Examples of such lures are known by trade names of “Flat Fish” and “Rapala”. There are numerous other lures which are patterned like Flat Fish and Rapala lures.

Flat Fish lures are made in an arcuate shape and exhibit a high frequency oscillation while drawn through water. The oscillation is highly unstable which results in twisting and ultimate tangling of line unless a swivel is used. Generally, the Flat Fish lures are not sufficiently heavy to be castable without some kind of weight added to a line to which the lure is affixed. Further, weight must also be added to sink the Flat Fish lure to a desired, predetermined trolling depth or for casting.

Rapala lures are currently the most popular of “lipped” lures. Plates affixed to the leading edge of Rapala lures are called lips and are primarily responsible for the lure's swimming action. Various displacement of lips relative to the front end of the lure determines whether the lure is a shallow or deep diving lure. Even so, unless a deep diving Rapala lure is heavily externally weighted, it is normally slow to sink and does not exhibit sinking characteristics associated with a jigging lure. Of course, jigging lures are also well known, most often being simplistic weights disposed about a hook shank. Jigs are -not known for realistic swimming motion.

Rapala and other lures may also be found as two part or two segment lures. Such lures are generally made in two parts to provide freedom for a back part to wag relative to a part being pulled. However, there are no known lures wherein a wagging of a back part substantially affects direction of motion of a front part.

Weighted lures are known in the fishing lure art. An example of a weighted fishing lure is disclosed in U.S. Pat. No. 4,317,305 issued May 2, 1982 to Herman P. Firmin (Firmin). Firmin discloses a frontally disposed weight member ahead of a resilient body. The body has a pair of recesses posteriorly disposed relative to the weight member and a thinned section of the body. Primary swimming simulation of the lure of Firmin is an oscillatory tail.

Examples of fishing lures which wobble are disclosed in U.S. Pat. Nos. 5,189,825 issued Mar. 2, 1993 to John E. Stewart (Stewart) and 5,381,623 issued Jan. 17, 1995 to James J. Crisp (Crisp). Stewart discloses a lure having a body which is flexibly connected to a framework which can remain stable while the body exhibits action; weight is frontally disposed relative to a head of the body. Crisp discloses a crank lure which connects a fishing line to the top of a lure head and disposes a hook superiorly and a tail inferiorly to cause the lure to remain upright and wobble.

Numerous weighted lures for jigging and the like are disclosed in U.S. Pat. Nos. 3,729,850, 5,119,581, 5,197,221 and 5,216,830. However, all of these lures have single weights and are designed to simply wobble or oscillate. In no case does an oscillatory motion of the weight substantially displace a head of any particular lure out of line with a towing fishing line.

### BRIEF SUMMARY AND OBJECTS OF THE INVENTION

In brief summary, this novel invention alleviates all of the known problems related to providing a castable lure which sinks in a manner similar to a jigging lure and which has an extraordinary swimming motion. The swimming motion is sufficiently random and diverse that, from time to time, the head of the lure is directed away from the direction of tow of a fishing line. The lure is internally weighted to assure a desired rate of sinking. Weighting of the lure can be varied to provide a variety of sinking rates without unduly affecting the swimming motion. Lures made according to the instant invention are generally vertically stable when displaced in water and thereby resist line twisting. Such lures are immediately impelled to a swimming motion when moved through water, permitting the lure to be swimmingly “jigged” from a lake or stream bottom. In such cases, lures, when jigged upward from the bottom, respond with an immediate realistic, non-repeating, somewhat random swimming motion. In addition, the lure can be towed or trolled over a wide range of velocities while continuing to exhibit a randomized and surprisingly realistic simulated swimming motion.

Generally, the lure is distinguishable as two parts, a head part and a tail part and is “lipless”. Each part is individually weighted and has a predetermined center of gravity site. Movement of the lure is compound or “bimodal”, based upon a first basic mode of action (wobble) of the head part and a second basic mode of action (wag) of the tail part.

A rear or aft portion of the head part is hingeably affixed to a fore portion of the tail part to permit the tail part to oscillate with a wagging motion somewhat independent of the head part. A novel connecting loop affixed to the head part permits fishing line to be affixed to the lure in a predetermined region above a center of gravity of the head part, yet below the top of the head and well below a dorsal area of the lure. The dorsal area (e.g. a fin), in cooperation with the loop which resides above the weight in the head, assures vertical stability of the head part. The head part is elongated and thinned rearward to form a vertical wedge toward the connection with the tail part.

The tail part has a pair of vertically disposed, inwardly angled, forward facing fascia which are juxtaposed relative to one another. In a preferred embodiment, the fascia form a “V” groove having a sufficiently open angle to permit the tail part to wag from side to side relative to the thinned rearward portion of the head part. It should be noted that the wagging of the tail part, somewhat randomly, causes the head part to wag also, displacing the entire lure from side to side in an irregular, but life-like swimming motion. The tail part is forced, by fluid flow into the groove and upon rear portions of the tail part, to wag, first toward one side and then back to the other. The weight in the tail part has a center of gravity which is distally disposed rearward from the hinge.

Sideways displacement of the tail part at the hinge tends to turn the head part causing sideways displacement and a resulting realistic swimming motion. A small notch, disposed at the top of the “V” groove, acts as a spoiler for fluid flowing between the head and tail parts and further smooths action of the tail part when displaced through a current. Further, the head part tends to wobble due to relative disposition of a fishing line connection and direction of pull through water, disposition of the head weight below the fishing line connection and the dorsal fin. Wobbling of the head part variably directs fluid flow toward different parts of the fascia adding to instability of the tail part to activate wagging motion.

In a preferred embodiment, the hinge functions as a two-part orthogonal eyelet hinge. For example, when using an eyelet hinge, that portion of the hinge which is affixed to the head part is vertically oriented. That portion of the hinge which is affixed to the tail part is horizontally oriented, permitting the tail part to wag from side to side.

Accordingly, it is a primary object to provide a fishing lure having a realistic swimming motion as it is displaced in water.

It is an important object to provide a castable lure which does not require additional weight added to a connecting fish line.

It is another important object to provide a lure which rapidly sinks in a manner expected of a jig.

It is an object to provide a lure which may be jigged.

It is an object to provide a jigging lure which jigs from a water bottom with a swimming motion.

It is an object to provide a lipless lure which, when displaced through water, exhibits a realistic swimming motion.

It is an object to provide a lure which is stable while being trolled and therefore does not twist line as a result of lure action.

It is an object to provide a lure which sinks without additional weight being added to a line affixed to the lure, thereby achieving a natural looking lure sans weights disposed on the line.

It is an object to provide a swimming lure which retains a substantially horizontal disposition while being towed or trolled through water.

It is an object to provide a compound or two part lure having one part which wobbles and one part which wags, the two parts interacting to provide rapid activation of a swimming motion and continued activation of a swimming motion through a wide range of lure speeds in water.

It is an object to provide a lure according to the invention which is operable as a part of a spinner bait lure system.

It is an object to provide a lure according to the invention which is operable as a part of a buzz bait lure system.

These and other objects and features of the present invention will be apparent from the detailed description taken with reference to accompanying drawings.

### BRIEF DESCRIPTION OF THE DRAWINGS

FIG. 1 is a lateral elevation of a lure affixed to a fishing line.

FIG. 2 is a lateral elevation of the lure seen in FIG. 1 with a loop articulated to facilitate fishing line attachment.

FIG. 3 is a top elevation of the lure seen in FIGS. 1.

FIG. 4 is a lateral elevation of the lure seen in FIG. 2 with parts removed so inner parts of the lure may be seen.

FIG. 5 is an exploded perspective of parts of the lure seen in FIGS. 1-4.

FIG. 6 is a side elevation of a lure, made in accordance with the instant invention, configured for jigging.

FIG. 7 is a magnified perspective of a wire frame forming a double loop with an opening for attaching to another loop.

FIG. 8 is a magnified perspective of a wire frame forming a double loop, each of the loops being closed.

FIG. 9 is a magnified perspective of an omega clip which provides an opening for attaching to another loop.

FIG. 10 is a side elevation of another embodiment of a lure made according to the invention and affixed to a spinner bait wire form.

FIG. 11 is a side elevation of another embodiment of a lure made according to the invention and affixed to a buzz bait wire form.

### DETAILED DESCRIPTION OF THE ILLUSTRATED EMBODIMENTS

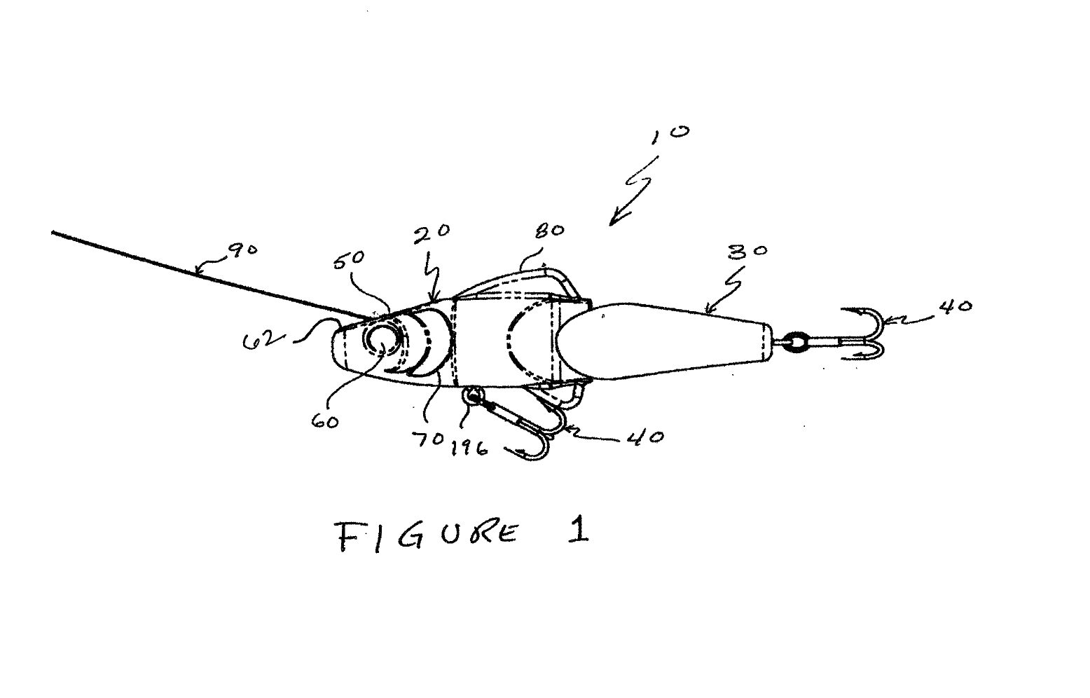

In this description, the term proximal is used to indicate the segment of the device normally closest to the object of the sentence describing its position. The term distal refers to the other end. Reference is now made to the embodiments illustrated in FIGS. 1-11 wherein like numerals are used to designate like parts throughout. As seen in FIG. 1, fishing lure 10 comprises a fore part 20 and a rear part 30. As seen in FIG. 1, fish hooks, generally numbered 40, may be affixed to either fore part 20 or rear part 30 or to both parts. It is preferable to have at least one hook affixed to rear part 30. Also ganged treble, single and other hook combinations which are lawful and legal may be affixed to lure 10 within the scope of the instant invention.

For realistic appearance, fore part 20 may have a frontal section 50 shaped to resemble a head of a fish, although other shapes may be used within the scope of the invention. As part of frontal section 50, a circular indentation 60 provides space whereat an eye may be affixed.

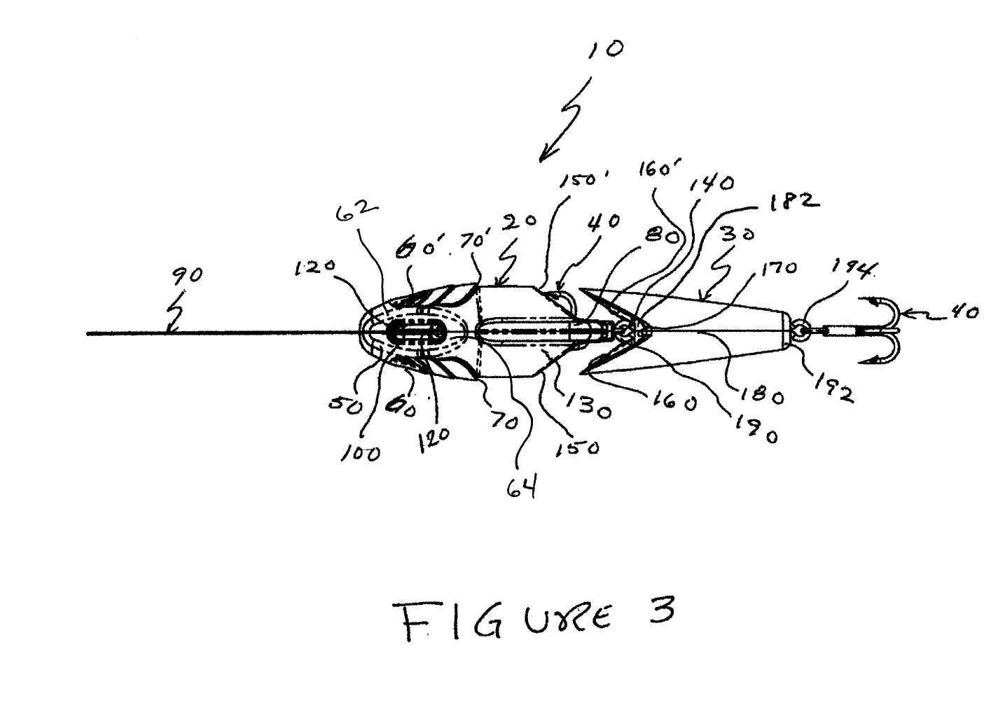

On the superior or top side 62 of frontal section 50, fore part 20 comprises a sloped, planar area 64 (See FIG. 3). It has been found that sloping area 64 at approximately 20° relative to the long axis of lure 10 greatly improves performance.

Other features which add realism to lure 10 may also be added, of which a gill line 70 is an example. Further, fore part 20 has a dorsal fin 80 disposed rearward from frontal section 50. Of course, similar features and markings are usually symmetrically disposed on both sides of lure 10. Generally, parts, features and markings which are represented by given numbers on one side of lure 10 and are replicated as mirror images on the other side of lure 10 are represented by primes of the given numbers on the one side.

Note in FIG. 1, that a fishing line, represented by a line segment 90 appears to extend out of frontal section 50 with no visible connecting loop. For optimal simulation of swimming, it has been experimentally determined that line segment 90 should be so disposed relative to frontal section 50 and dorsal fin 80 to provide optimal wobble of fore part 20. While other sites of line connection may be used within the scope of the instant invention, such a connection is recommended.

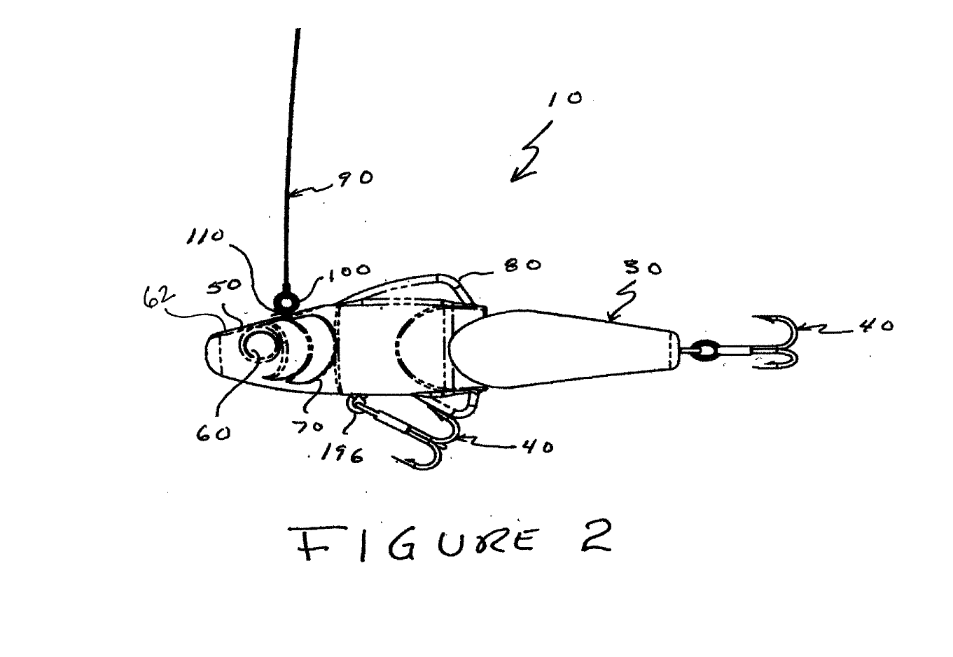

To accomplish such a fishing line connection, a line connecting loop 100 of an articulating hinge member 110 is provided as is seen in part in FIG. 2. By articulating member 110 upward as seen in FIG. 2, a fishing line, such as line segment 90, may be facilely affixed by a fisherman's knot. Once lure 10 is disposed in water where fish motion relative to the water causes resistance to pull forces exerted via line segment 90, hinge member 110 is downwardly displaced to at least partially hide articulating member 110 as seen in FIG. 1. While such a hinge member is preferred for optimum performance, a more standard fixed loop (not shown) may be used within the scope of the invention.

As seen in FIG. 3, frontal section 50 comprises a slot 120 into which connecting loop 100 articulates by resistive forces which occur when lure 10 is displaced through water. Distal from frontal section 50, fore part 20 has a thinned section 130 proximal to a connecting hinge link 140 by which rear part 30 is hingeably affixed to fore part 20. As best seen in FIG. 3, thinned section 130 has a pair of inwardly disposed faces 150 and 150′ which provide boundary layer surfaces for water being displaced along fore part 20.

Rear part 30 comprises a pair of forwardly disposed angled faces 160 and 160′. Faces 160 and 160′ cooperate to form a wedge 170 along a midline 180 of rear part 30. Though not absolutely necessary to the invention, disposed at the top of wedge 170 is a notch 182 which acts as a spoiler for fluid flow thereat and thereby stabilizes and improves swimming action. Rear part 30 is hingeably joined to hinge link 140 via another link 190. At aft end 192, rear part 30 comprises a hook loop 194 whereby a hook 40 is affixed thereto. Though not required within the scope of the invention, rear part 30 is also thinned posteriorly. Note also, in FIGS. 1 and 2, that a hook 40 is affixed to fore part 20 by a hook loop 196. As is understood by fishermen and those skilled in fishing lure art, only one hook is required on a lure, though multiple hooks may make a lure more efficient. Also different hook combinations may be affixed to lure 10, such, for example, as ganged treble hoods and single hooks, so long as such may be affixed to a lure within legal limits.

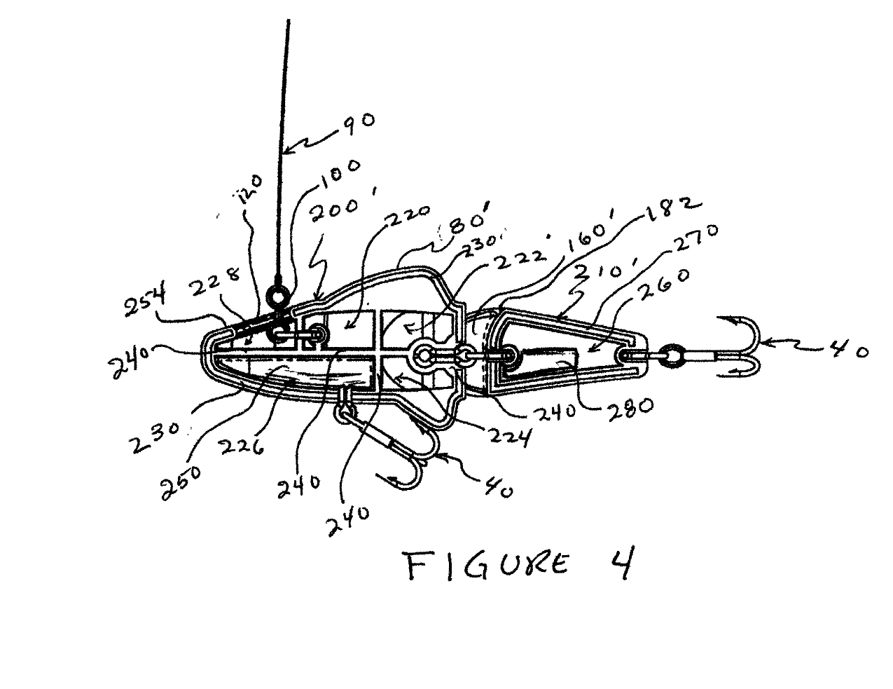

Although lure 10 may be manufactured in many ways within the scope of the invention, one mode of lure 10 construction is seen in FIGS. 4 and 5. As seen in FIG. 5, fore part 20 may be molded as two separate parts, numbered 200 and 200′. Similarly rear part 30 may be molded as two separate parts, numbered 210 and 210′.

Reference is now made to FIG. 4 wherein facing halves, parts 200 and 210, of lure 10 have been removed for clarity of presentation. It should be noted that all features disclosed for parts 200′ and 210′ are repeated in mirror image format in parts 200 and 210, except for complimentary features which are disclosed hereafter.

Part 200′ comprises a portion 80′ of dorsal fin 80 which is integrally molded as a part of part 200′. Inferiorly disposed relative to dorsal fin portion 80′, part 200′ comprises a plurality of cavities 220, 222, 224, 226 and 228. Further, part 200′ comprises raised edging, generally number 230, which acts as a tongue and groove relationship with part 200 to permit parts 200′ and 200 to be joined and sealed to form a single part (i.e. fore part 20). An internal structure, generally numbered 240, separates cavities 220, 222, 224, 226 and 228 from each other. As it may be desired, though not required, to sequester gas (air) within some of the cavities (e.g. cavities 220 and 222) to improve lure 10 stability, structure 240 may be raised in part or in total to perform as a tongue in a tongue and groove relation with complementary portions of part 200 (not shown) to independently seal selected cavities.

Note a weight 250 disposed in cavity 226. It is important that weight 250 (or at least the center of gravity of weight 250) be inferiorly disposed to a site where forces from line 90 are imposed upon lure 10. So disposed, weight 250 in combination with superiorly displaced connection of line 90 and superior features of which dorsal fin 80 is an example, causes fore part 20 to wobble as it is displaced relative to a surrounding fluid (water) environment. The mass and density of weight 250 may be varied to adjust for predetermined fishing depth of lure 90, rate of sinking when lure 90 is jigged, ease of casting of lure 90 and other variables which characterize lure 90 for a desired fishing method. As an example, for a lure having a fore part 20, shaped as seen in FIGS. 1-3, having a maximum girth of 1.2 centimeters and a length of 3.75 centimeters, weight 250 may be approximately nine grams.

Superiorly, cavity 228 is open at slot 120 into which connecting loop 100 articulates to be hidden as lure 10 is displaced through water. A subtle feature of fore part 20 is a sloped planar face 254 disposed about slot 120. Planarity of face 254 markedly improves wobble action of fore part 20.

Part 210′, as seen in FIG. 4, comprises an open cavity 260 which is generally outlined by a raised edging 270. Like edging 230, edging 270 acts as a tongue in a tongue and groove relationship with part 210 to permit parts 210′ and 210 to joined and sealed to form a rear part (i.e. rear part 30). Edging 270 outlines cavity 260, which when parts 210′ and 210 are joined, houses a weight 280. Weight 280 may be disposed such that the center of gravity is along the line of force of pull of line 90. The center of gravity may be even higher if weight 250 is sufficiently heavy and so disposed to provide stability in light of disposition of weight 280. However, it is generally advisable to have the center of gravity of weight 280 disposed below the line of force of pull of line 90. For a rear part 30 having a shape consistent with part 30 seen in FIGS. 1-3 and a length of 3.75 centimeters, weight 280 may be approximately 1.8 grams.

Assembly of lure 10 may be determined by review of FIGS. 5 and 7-9. A plurality of loop connections are made to connect fore part 20, rear part 30 and hooks 40 to provide an operable lure which is affixable to a line 90. It should be duly noted that the loop connections are for the most part exemplary and other types of connections, especially hinge connections, may be made to assemble lure 10 within the scope of the invention.

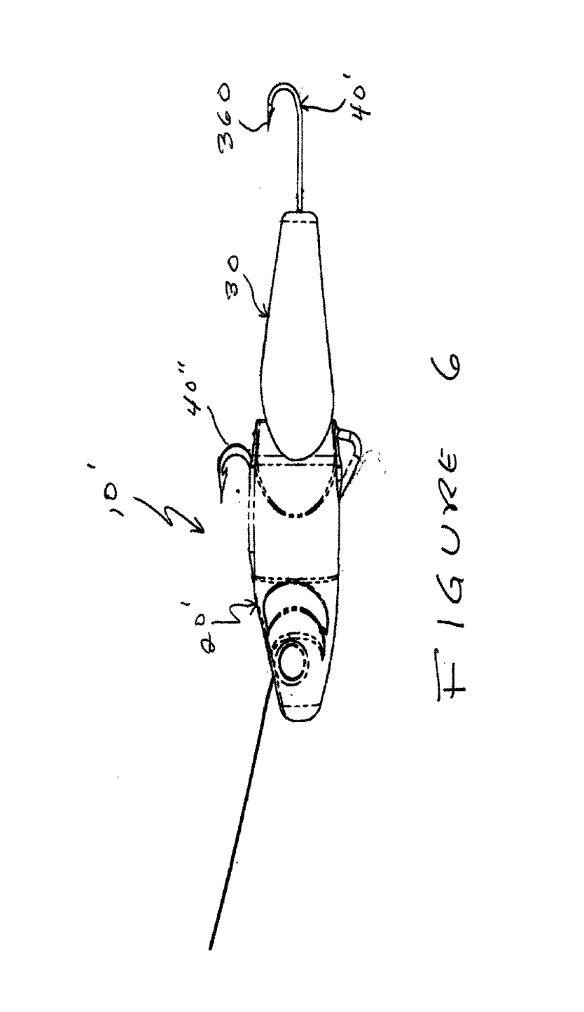

One mode of connection may be made using a double loop snap ring 300, as seen in FIG. 7. Snap ring 300 comprises a wire frame 302 which defines an accessible opening 304 formed at wire ends 306 and 308. Opening 304 is directly associated with a proximal loop 310 and a distal loop 312. Note that a separate loop may be displaced through opening 304 into loop 310 and therefrom by separating closing portions of frame 302 further into loop 312. Ring 300 is generally made of metal having sufficient spring to permit separation of closing portions of frame 302 and to reclose the separating portions of frame 302 to retain a loop in frame 302, unless removed by force, thereafter. Snap rings, like ring 300, are generally commercially available.

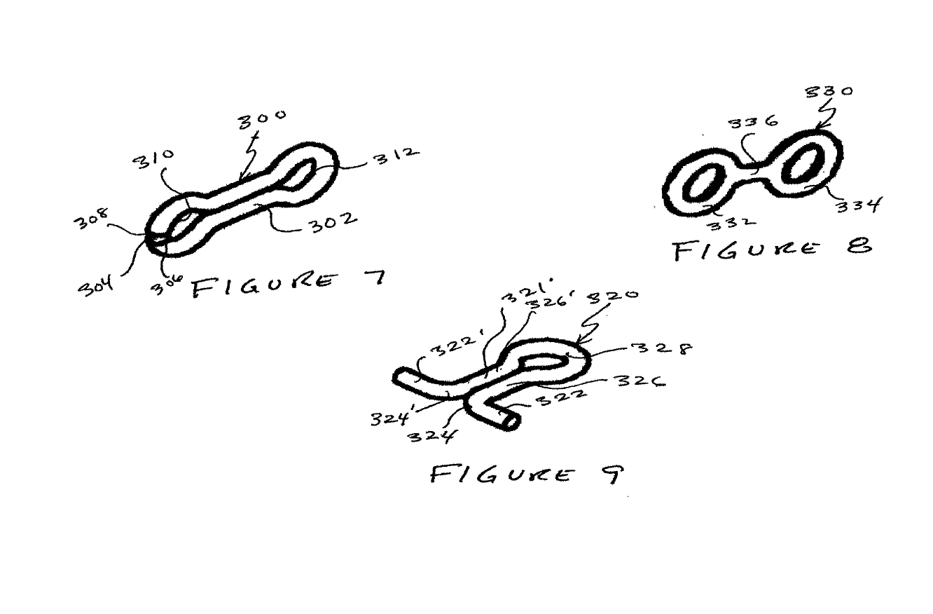

Another mode of connection is an omega clip 320 seen in FIG. 9. Omega clip derives its name from being shaped like the Greek character omega. Clip 320 comprises a wire frame 321 having pair of outwardly disposed arms, 322 and 322′ which may be used as anchors to affix clip 320 to a structure. As seen in FIG. 9, each arm 322 and 322′ comprises a bend 324 and 324′, respectively, to respectively extend into two parallel compressively joined segments 326 and 326′. Distal from bends 324 and 324′, segments 326 and 326′ separate to join in common arcuate loop 328. Similar to snap ring 300, omega clip is generally made from a spring metal and is commercially available as a separate part.

A closed double loop connector 330 is seen in FIG. 8. Connector 330 is generally dumb bell shaped having a pair of loops 332 and 334 and an intervening stem 336. Connector 330 may be made from metal or synthetic resinous material and various useful sizes and types of connector 330 are commercially available.

It may be noted in FIG. 5 that connecting components used in lure 10 are made up of a plurality of snap rings 300, omega clips 320 and connectors 330. For clarity, in FIG. 5 each individual ring, clip or connector is referenced by a number and a following character to specifically mark and identify each connecting component. As an example, a connector associated with hinge member 110 (see FIG. 2) is numbered 330A. Please note that dashed lines provide an indication of direction of displacement for assembly of parts to construct lure 10.

To affix connecting components to parts 200, 200′, 210 and 210′, each such part has a structure which comprises slots or holes in which the connecting components are securely anchored. As an example, part 200′ has a blind hole 340 in which an arm 322′ of omega clip 320A is inserted. Rearward from hole 340, part 200′ has a slot which is formed to anchor loop 310 of snap ring 300B.

Inferiorly disposed relative to hole 340, part 210′ has a slot 343 through which frame 302 of snap ring 300C is displaced such that loop 310 resides inside cavity 226.

Part 210′ has a blind hole 344 for anchoring arm 322′ of omega clip 320B. Rearward from hole 344, part 210′ has another blind hole 346 of arm 322′ of omega clip 320C.

Though not shown, parts 200 and 210 have holes or slots which are complementary to those mentioned above for engaging and anchoring the referenced connecting components. Also for clarity, each hook 40 comprises a connecting loop 350.

To assemble the part 200′ portion of lure 10, loop 334 of connector 330A is displaced into loop 328 of omega clip 320A. Arm 322′ of omega clip 320A is displaced into blind hole 340. In this manner, loop 328 of omega clip 320A performs as loop 100. (See FIG. 2-4). Loop 328 of omega clip 320B is displaced into loop 312 of snap ring 300B. So assembled loop 310 of snap ring 300B is displaced into slot 342. A loop 350 (earlier referenced as loop 196) of a hook 40 is displaced into loop 312 of snap ring 300C. Loop 310 of snap ring 300C is affixed to weight 250 such that weight 250 and a portion of snap ring 300C is disposed in cavity 226 with at least loop 312 of snap ring 300C inferiorly exposed outside part 210′. Loop 310 may be affixed to weight 250 by carving a slot in weight 250 and adhesively affixing loop 310 therein or by molding loop 310 in place if weight 250 is formed by hot molding.

Part 210′ may be assembled by affixing loop 350 (earlier referenced in FIG. 3 as loop 194) of a hook 40 to loop 328 of omega clip 320C. Weight 280 is displaced into cavity 260. Arm 322′ is then displaced into blind hole 346. Displacing arm 322′ into blind hole 344 hingeably affixes part 200′ to part 210′. Note that loop 312 of snap ring 300B is vertically oriented and loop 328 of omega clip 320B is horizontally oriented. So oriented, these loops promote wobble in fore part 20 and a wagging motion in rear part 30.

Following assembly of parts 200′ and 210′, part 200 is securely affixed to part 200′ and part 210 is similarly securely affixed to part 210′ to complete assembly of lure 10. These parts may be affixed mechanically, by adhesion, solvent bonding or by other processes such as ultrasonically. To use lure 10 for most fishing methods, only a line 90 need be affixed thereto. Lure 10 is inherently weighted for casting or trolling and is inherently stable when displaced through water, therefore not requiring connections using swivels.

The most surprising feature of lure 10 is its realistic swimming motion in water. That action is the result of a distinctive wobble which results from fore part 20 structure, line 90 attachment site and weight 250 disposition. As water flows relative to inwardly disposed faces 150 and 150′ and as fore part 20 cants and wobbles, flow vectors are variously directed against faces 160 and 160′ causing a wagging mode of action of rear part 30. Wagging of rear part 30 is fed back through the hinged connection of link 140 (loop 312 of snap ring 300B) to link 190 (loop 328 of omega clip 320B). This creates a compound motion or action which appears to randomly thrust frontal section 50 from side to side while wobbling. The result is a swimming action in which both rear part 30 (the tail) wags while the fore part 20 (the head) departs randomly from direction lure 10 is being pulled. This action continues through widely dispersed velocities of water displacement rate of lure 10 and begins immediately upon such displacement.

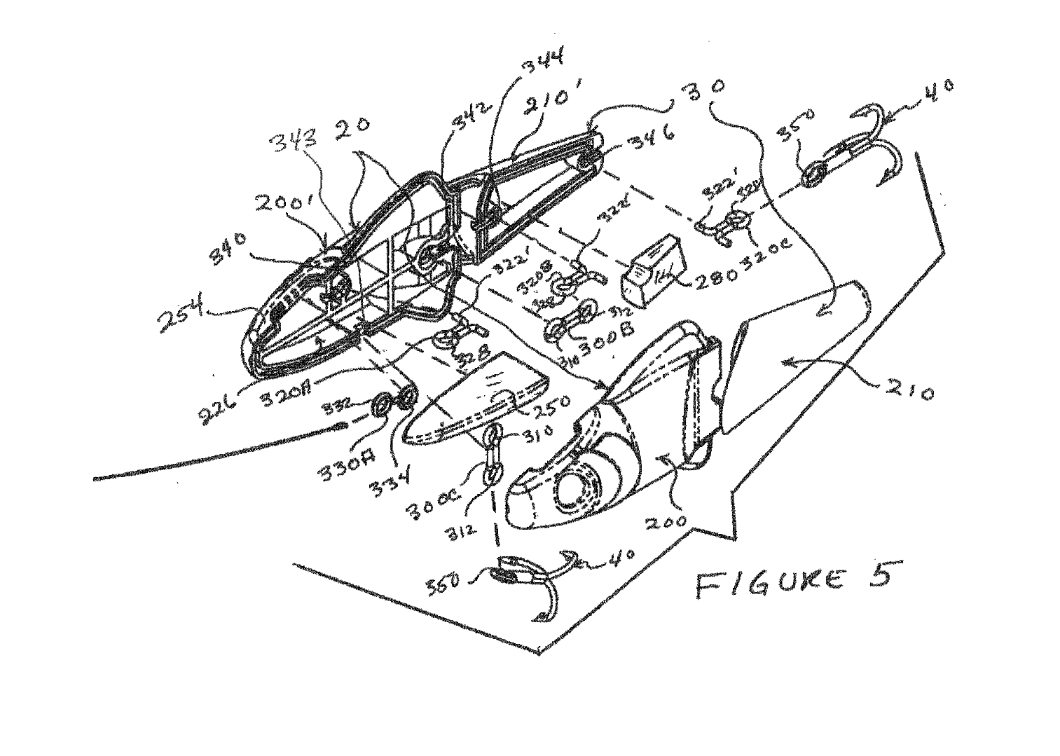

Such immediacy of action makes a lure made according to the instant invention particularly appealing for jigging. A lure 10′ which is better suited for some jigging applications is seen in FIG. 6. Lure 10′ is similar in most form and function to lure 10 except for hook attachment and use, Note that an upright hook 40′ is affixed to rear part 30 of lure 10′. Upright hook 40′ has a vertically disposed barb 360 to minimize snagging while jigging. Also, a second upright hook 40″ is disposed as a replacement for dorsal fin 80. It has been experimentally determined that such a replacement of dorsal fin 80 by a hook such as hook 40″ results in a mode of action by lure 10′ which is substantially the same as the action of lure 10.

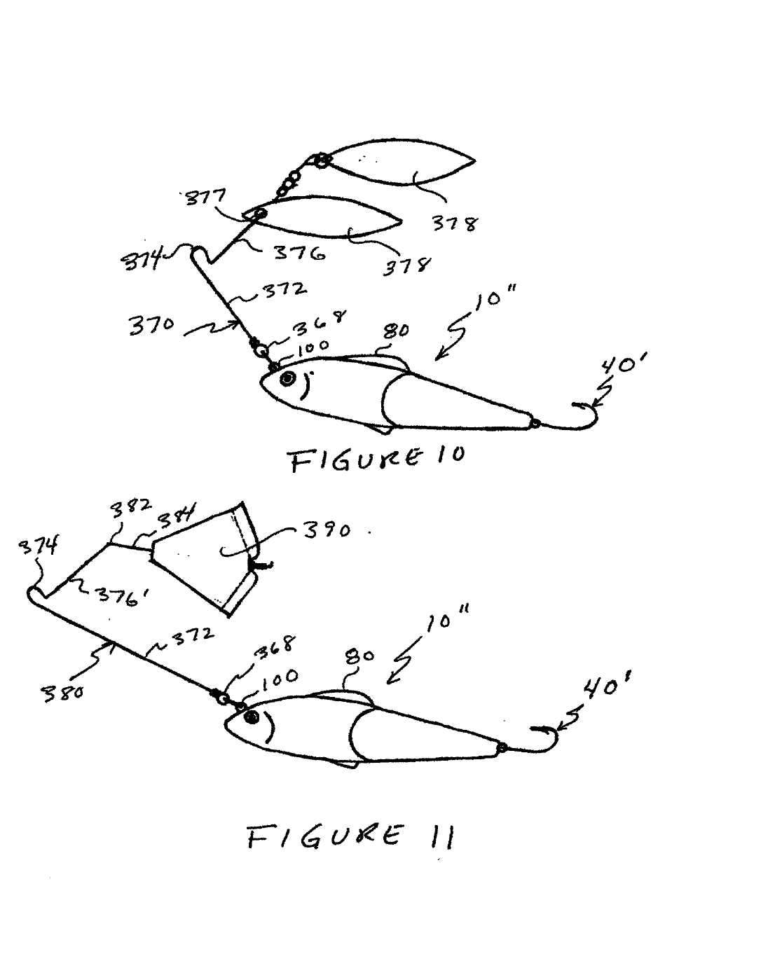

Reference is now made to FIGS. 10 and 11 where another embodiment of the invention in the form of lure 10″ is used variously as a spinner bait (FIG. 10) and as a buzz bait (FIG. 11). Lure 10″ is formed as a combination of parts of lures 10 and 10′. Lure 10″ comprises a rearly disposed upright hook 40′, similar to lure 10′ and a dorsal fin 80, similar to lure 10.

As seen in FIG. 10, lure 10″ is affixed, via loop 100 to a swivel connector 368 wire form 370. Note that inherent stability of lure 10″ permits nearly any kind of fishing lure connection to be made between wire form 370 and loop 100. Wire form 370 is a part of a spinner system 371. Spinner systems, of which spinner system 371 is an example, are well known and in wide use by fishermen. Wire form 370 has a well known shape, comprising an elongated substantially straight section 372 extending outward from swivel connector 368 and arching in a nearly 360° turn at a bend 374 to extend rearward via a second elongated section 376, to a connection point 377 where two spinner blades, generally numbered 378, are affixed. Usually a fishing line is affixed at bend 374 for trolling and jigging.

In FIG. 11, a wire form 380 is affixed through a swivel connection 369 to lure 10″. Wire form 380 is similar in form to wire form 370, except at an end distal to lure 10″ an elongated section 376′ has a bend 382 before extending horizontally along a shorter section 384 to connect to a buzz blade 390. Wire forms, similar to wire form 380 and buzz blades are well known in fishing art.

In both configurations seen in FIGS. 10 and 11, lure 10″ is effective first because it is weighted and inherently stable, but second because vital swimming action of lure 10″ adds significantly to action of the combinations of lure 10″ and wire forms 370 and 380, with spinners 378 and buzz blade 390.

In all embodiments, the fore part, such as fore part 20 (e.g. parts 200 and 200′), and the rear part, such as rear part 30 (e.g. parts 210 and 210′), are preferably injection molded from synthetic resinous material which may be facilely joined by being mechanically affixed, adhesed, solvent bonded or by other processes, such as by ultrasound. As well a synthetic resinous material should be selected which can withstand the rigors of casting and trolling. There are many such materials which are commercially available including a variety of polycarbonates.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A lipless castable and jiggable compound action fishing lure which simulates a swimming motion due to bimodal action when displaced through water, said lure comprising:
a fore part comprising a loop which communicates with a fishing line to displace the fishing lure in water in a predetermined direction, a stabilizing structure, superiorly disposed relative to the loop, and a weight inferiorly disposed relative to the stabilizing structure for the purpose of cooperating with the stabilizing structure to cause the fore part to wobble as a first action mode when the lure is so displaced;
a tail part comprising a connecting hinge by which the tail part is hingeably affixed to said fore part, said tail part further comprising a pair of forward facing fascia and a weight disposed rearward from said fascia which cooperate to cause the tail part to wag from side to side as a second action mode when the lure is so displaced, said weight having sufficient mass to communicate side to side displacement to the fore part to transiently steer the lure from the predetermined direction thereby resulting in the simulated swimming motion.

2. The castable and jiggable compound action fishing lure according to claim 1 wherein the connecting hinge is an eyelet hinge.

3. The castable and jiggable compound action fishing lure according to claim 2 wherein said eyelet hinge comprises a fore part which is vertically disposed.

4. The castable and jiggable compound action fishing lure according to claim 1 wherein the fore part comprises a loop whereat a fish hook is affixed.

5. The castable and jiggable compound action fishing lure according to claim 1 wherein the tail part comprises a loop whereat a fish hook is affixed.

6. The castable and jiggable compound action fishing lure according to claim 1 wherein the pair of forward facing fascia are inwardly angled to define a vertically disposed “V” groove.

7. The castable and jiggable compound action fishing lure to claim 6 wherein said “V” groove comprises a superiorly disposed notch.

8. The castable and jiggable compound action fishing lure according to claim 1 where in the fore part comprises an elongated fore body part having a medially disposed first long axis, a fore part vertical dimension which comprises a superiorly disposed fore body part region relative to the first long axis and an inferiorly disposed fore part region relative to the first long axis and a fore body part horizontal dimension which defines fore body part body width about the first long axis.

9. The castable and jiggable compound action fishing lure according to claim 8 wherein the tail part comprises a second medially disposed long axis a tail body part vertical dimension which comprises a superiorly disposed tail body part region relative to the second long axis and an inferiorly disposed tail body part region relative to the second long axis and a tail body part horizontal dimension which defines tail part body width about the second long axis.

10. The castable and jiggable compound action fishing lure according to claim 9 wherein said weight of said fore part has a center of gravity which is inferiorly disposed relative to said first long axis, the stabilizing structure is a dorsal fin superiorly disposed relative to said first long axis and the loop for communicating with a fishing line being superiorly disposed relative to said first center of gravity and inferiorly disposed relative to said dorsal fin such that pendulous action between forces acting upon the dorsal fin and first weight about the loop communicating with the fishing line causes the fore part to wobble.

11. The castable and jiggable compound action fishing lure according to claim 10 wherein said fore part further comprises a body segment which is trimmed towards the hinged connection to enhance fluid flow toward the hinge connection.

12. The castable and jiggable compound action fishing lure according to claim 11 wherein the weight of said tail part has a center of gravity which is inferiorly disposed relative to said second long axis, and the pair forward facing fascia.

13. The castable and jiggable compound action fishing lure according to claim 1 wherein the fishing line communicating loop is an articulating loop hingeably affixed to the fore part to provide facile access to the loop while a fishing line is affixed thereto and rotated to a site hidden from a side view of the fore part when the lure is towed through water.

14. The castable and jiggable compound action fishing lure according to claim 1 wherein the fore part comprises a planar area about the fishing line communicating loop, said area being rearly sloped upward.

15. The castable and jiggable compound action fishing lure according to claim 14 wherein the planar area comprises an angular upward slope of approximately 20°.

16. A weighted fishing lure for jigging, casting and trolling, said fishing lure comprising:
an elongated head part having a medially disposed first long axis, a head part vertical dimension which comprises a superiorly disposed head part region relative to the first long axis and an inferiorly disposed head part region relative to the first long axis and a head part horizontal dimension which defines head part body width about the first long axis;
an elongated tail part, which is connected via a hinge to the head part, having a second medially disposed long axis a tail part vertical dimension which comprises a superiorly disposed tail part region relative to the second long axis and an inferiorly disposed tail part region relative to the second long axis and a tail part horizontal dimension which defines tail part body width about the second long axis;
said head part comprising a first weight having a center of gravity which is inferiorly disposed relative to said first long axis, a dorsal structure superiorly disposed relative to said first long axis and a loop for communicating with a fishing line disposed superiorly disposed relative to said first center of gravity and inferiorly disposed relative to said dorsal structure such that pendulous action between forces acting upon the dorsal structure and first weight about the loop communicating with a towing fishing line causes the head part to wobble;
said head part further comprising a body segment which is trimmed towards the hinged connection to enhance fluid flow toward the hinge connection;
said tail part comprising a second weight, having a center of gravity disposed rearward from said hinge connection, and a pair of vertically disposed fascia, inwardly angled relative to the second long axis to variously oppose fluid flow along the body segment to thereby result in a wagging motion of the tail part;
said second weight having sufficient mass to communicate wagging energy to the head part through the hinge connection to displace the head part sideways.

17. The weighted fishing lure for jigging, casting and trolling according to claim 16 wherein the connecting loop is an articulating loop affixed to provide facile access to the loop while a fishing line is affixed thereto and rotated to a site hidden within the head part when the lure is towed through water.

18. The weighted fishing lure for jigging, casting and trolling according to claim 16 wherein the head part comprises a loop whereat a fish hook is affixed.

19. The weighted fishing lure for jigging, casting and trolling according to claim 16 wherein the pair of vertically disposed fascia, inwardly angled define a vertically disposed “V” groove.

20. A method for actuating a fishing lure to simulate swimming of a living organism, said method comprising the steps of:
providing a fishing lure having an elongated head part, having a medially disposed first long axis, a head part vertical dimension which comprises a superiorly disposed head part region relative to the first long axis and an inferiorly disposed head part region relative to the first long axis and a head part horizontal dimension which defines head part body width about the first long axis, and an elongated tail part, which is connected via a hinge to the head part, having a second medially disposed long axis a tail part vertical dimension which comprises a superiorly disposed tail part region relative to the second long axis and an inferiorly disposed tail part region relative to the second long axis and a tail part horizontal dimension which defines tail part body width about the second long axis;
in the head part, providing a first weight having a center of gravity which is inferiorly disposed relative to said first long axis, a dorsal structure superiorly disposed relative to said first long axis and a loop for communicating with a fishing line superiorly disposed relative to said first center of gravity and inferiorly disposed relative to said dorsal structure such that pendulous action between forces acting upon the dorsal structure and first weight about the loop which communicates with the fishing line causes the head part to wobble;
also in the head part providing a body segment which is trimmed towards the hinged connection to enhance fluid flow toward the hinge connection;
in the tail part providing a second weight, having a center of gravity disposed rearward from said hinge connection, and a pair of vertically disposed fascia, inwardly angled relative to the second long axis to variously oppose fluid flow along the body segment to thereby result in a wagging motion of the tail part such that said second weight has sufficient mass to communicate wagging energy to the head part through the hinge connection to displace the head part sideways;
affixing the head part of said lure to fishing line;
displacing said lure through water in line with force directed through the fishing line thereby causing said head part to wobble and fluid to be displaced toward the fascia resulting in wagging of said tail part;
translating wagging energy of said tail part through energy stored in said second weight to said head part to direct the lure transversely relative to the directed line of force, thereby causing randomly directed lateral movement and simulated swimming by the lure.
